(19) United States
(12) Patent Application Publication
(10) Pub. No.: US 2026/0213147 A1
(43) Pub. Date: Jul. 23, 2026

(54) SYSTEMS AND METHODS FOR REDUCING DATA STORAGE REQUIREMENTS IN MASS ANALYSIS SYSTEMS

(71) Applicant: DH Technologies Development Pte. Ltd., Singapore (SG)

(72) Inventor: Stephen TATE, Barrie (CA)

(73) Assignee: DH Technologies Development Pte. Ltd., Singapore (SG)

(21) Appl. No.: 19/138,965

(22) PCT Filed: Dec. 15, 2023
(86) PCT No.: PCT/IB2023/062802

§ 371 Date: Jun. 13, 2025

Related U.S. Application Data
(60) Provisional application No. 63/387,870, filed on Dec. 16, 2022.

(51) Int. Cl. H01J 49/00

(52) U.S. Cl. CPC H01J 49/0036

(57) ABSTRACT

A method and system for reducing data storage requirements in mass spectrometry data analysis, the method including ionizing a plurality of samples from a sample repository, and for at least one ionized sample of the plurality of samples, capturing a plurality of mass spectra over a period of time, generating an ion chromatogram based on the captured plurality of mass spectra, the ion chromatogram extending over the period of time, isolating an individual peak of the ion chromatogram, determining at least one of a starting point, an apex, and an ending point of the isolated individual peak, correlating the determined at least one of the starting point, the apex and the ending point to the ionized sample, and storing the correlated at least one of the starting point, the apex, the ending point and the ionized sample in a data repository.

### CROSS-REFERENCE TO RELATED APPLICATION

This application is being filed on Dec. 15, 2023, as a PCT International Patent Application that claims priority to and the benefit of U.S. Provisional Application No. 63/387,870, filed on Dec. 16, 2022, which is hereby incorporated by reference in its entirety.

### BACKGROUND

Data collection in mass analysis systems typically requires large amounts of data storage. Typically, the collected data is stored as a spectrum of a range of masses, and a spectrum is recorded and stored for each of the masses.

### SUMMARY

In one aspect, the technology relates to method for reducing data storage requirements in mass spectrometry data analysis, the method including ionizing a plurality of samples from a sample repository, and for at least one ionized sample of the plurality of samples: capturing a plurality of mass spectra over a period of time, generating an ion chromatogram based on the captured plurality of mass spectra, the ion chromatogram extending over the period of time, isolating an individual peak of the ion chromatogram, determining at least one of a starting point, an apex, and an ending point of the isolated individual peak, correlating the determined at least one of the starting point, the apex and the ending point to the ionized sample, and storing the correlated at least one of the starting point, the apex, the ending point and the ionized sample in a data repository.

In an example of the above aspect, the method further includes identifying the ionized sample based on the determined starting point, apex, and ending point. In another example, determining the apex includes identifying an apex time of the isolated individual peak; and calculating a first sum of a first plurality of mass spectra at the apex time of the isolated individual peak. In yet another example, calculating the first sum includes calculating the sum of four spectra at the apex time of the isolated individual peak. In a further example, determining the starting point includes identifying a starting time of the isolated individual peak, and calculating a second sum of a second plurality of mass spectra at the starting time of the isolated individual peak. For example, calculating the second sum includes calculating the sum of three spectra at the starting time of the isolated individual peak.

In further examples of the above aspect, determining the ending point includes identifying an ending time of the isolated individual peak, and calculating a third sum of a third plurality of mass spectra at the ending time of the isolated individual peak. For example, calculating the third sum includes calculating the sum of three spectra at the ending time of the isolated individual peak. In other examples, storing the determined at least one of the starting point, the apex and the ending point includes determining a location of the ionized sample in the sample repository, associating the location of the ionized sample with the determined at least one of the starting point, the apex and the ending point, and storing the associated location and determined at least one of the starting point, the apex and the ending point in the data repository. In another example, the method further includes determining a background intensity at the starting point and at the ending point of the isolated individual peak, wherein determining the apex of the isolated individual peak includes subtracting the determined background intensity from an intensity of the determined apex. In other examples, isolating the individual peak includes combining a plurality of peaks during the period of time. In other examples, storing can include storing one or more of the summed spectra at the starting point, ending point or apex in the data repository.

In another aspect, the technology relates to method for reducing data storage requirements in mass spectrometry data analysis, the method including ionizing a plurality of samples from a sample repository, and for at least one ionized sample of the plurality of samples: capturing a plurality of mass spectra over a period of time, generating an ion chromatogram for the ionized sample based on the captured plurality of mass spectra, the ion chromatogram extending over the period of time, isolating an individual peak of the ion chromatogram, determining an intensity of the isolated individual peak, correlating the determined intensity with the ionized sample, and storing the correlated intensity and the ionized sample in a data repository.

In another example of the above aspect, the method further includes identifying the ionized sample based on the determined intensity. In other examples, storing the determined intensity includes determining a location of the ionized sample in the sample repository, associating the location of the ionized sample with the determined intensity, and storing the associated location and determined intensity in the data repository.

In another aspect, the technology relates to a sample analyzing system that includes a sample receiver, an ionization device coupled to the sample receiver, a mass analysis device fluidically coupled to the ionization device, a processor operatively coupled to the sample receiver and to the mass analysis device, and a memory coupled to the processor, the memory storing instructions that, when executed by the processor, perform a set of operations. In one aspect, the set of operations includes ionizing, at the ionization device, a plurality of samples received from a sample repository, and for at least one ionized sample of the plurality of samples, the set of operations further includes capturing, at the mass analysis device, a plurality of mass spectra over a period of time, generating, via the processor, an ion chromatogram based on the captured plurality of mass spectra, the ion chromatogram extending over the period of time, isolating, via the processor, an individual peak of the ion chromatogram, determining, via the processor, at least one of a starting point, an apex, and an ending point of the isolated individual peak, correlating, via the processor, the determined at least one of the starting point, the apex and the ending point to the ionized sample, and storing, at the memory, the correlated at least one of the starting point, the apex, the ending point and the ionized sample.

In another example of the above aspect, the system further includes an acoustic ejector configured to eject the ionized sample from the sample repository into the sample receiver. In a further example, the sample receiver includes an open port interface. In yet another example, the acoustic ejector is a non-contact sample ejector. In a further example, the mass analysis device includes a mass spectrometer.

In other examples of the above aspect, the set of operations further includes identifying the ionized sample based on the determined starting point, apex, and ending point. In another example, the set of operations further includes identifying an apex time of the isolated individual peak, and calculating a first sum of a first plurality of mass spectra at the apex time of the isolated individual peak. For example, the set of instructions includes calculating the first sum by calculating the sum of four spectra at the apex time of the isolated individual peak. In further examples, the set of operations includes determining the starting point by identifying a starting time of the isolated individual peak, and calculating a second sum of a second plurality of mass spectra at the starting time of the isolated individual peak.

In other examples of the above aspect, the set of instructions includes calculating the second sum by calculating the sum of three spectra at the starting time of the isolated individual peak. In a further example, the set of operations includes determining the ending point by identifying an ending time of the isolated individual peak, and calculating a third sum of a third plurality of mass spectra at the ending time of the isolated individual peak. In a further example, the set of operations includes calculating the third sum by calculating the sum of three spectra at the ending time of the isolated individual peak. In yet another example, the set of operations includes storing the correlated at least one of the starting point, the apex and the ending point by determining a location of the ionized sample in the sample repository, associating the location of the ionized sample with the determined at least one of the starting point, the apex and the ending point, and storing the associated location and determined at least one of the starting point, the apex and the ending point in the data repository. In yet other example, the set of instructions further includes determining a background intensity at the starting point and at the ending point of the isolated individual peak, wherein determining the apex of the isolated individual peak includes subtracting the determined background intensity from an intensity of the determined apex. In a further example, the set of operations further includes isolating the individual peak by combining a plurality of peaks during the period of time.

In another aspect, the technology relates to a sample analyzing system that includes a sample receiver, an ionization device coupled to the sample receiver, a mass analysis device fluidically coupled to the ionization device, a processor operatively coupled to the sample receiver and to the mass analysis device, and a memory coupled to the processor, the memory storing instructions that, when executed by the processor, perform a set of operations. In one aspect, the set of operations includes ionizing, at the ionization device, a plurality of samples from a sample repository, and for at least one ionized sample of the plurality of samples, the set of operations includes capturing, at the mass analysis device, a plurality of mass spectra over a period of time, generating, via the processor, an ion chromatogram for the ionized sample based on the captured plurality of mass spectra, the ion chromatogram extending over the period of time, isolating, via the processor, an individual peak of the ion chromatogram, determining, via the processor, an intensity of the isolated individual peak, correlating, via the processor, the determined intensity with the ionized sample, and storing, at the memory, the correlated intensity and the ionized sample.

In another example of the above aspect, the set of instructions further includes identifying the ionized sample based on the determined intensity. In a further example, the set of instructions further includes storing the determined intensity by determining a location of the ionized sample in the sample repository, associating the location of the ionized sample with the determined intensity, and storing the associated location and determined intensity in the memory.

### BRIEF DESCRIPTION OF THE DRAWINGS

FIG. 1 is a schematic view of an example system combining acoustic droplet ejection (ADE) with an open port interface (OPI) sampling interface and electrospray ionization (ESI) source.

FIG. 2 is a schematic diagram illustrating operation of another particular example system in accordance with various examples of the disclosure.

FIG. 3 is an example diagram illustrating the obtention of product ion traces from various precursor ion mass selection windows, in accordance with various examples of the disclosure.

FIG. 4 is an example diagram that shows the three-dimensionality of an extracted ion chromatograph (XIC) obtained for a precursor ion mass selection window over time, in accordance with various examples of the disclosure.

FIGS. 5A-5C illustrate data acquisition traces, according to various examples of the disclosure.

FIGS. 6A-6B are flow charts illustrating example methods for reducing data storage requirements in mass analysis systems, in accordance with various examples of the disclosure.

FIG. 7 depicts a block diagram of a computing device.

### DETAILED DESCRIPTION

Acoustic Ejection Mass Spectrometry (AEMS) is a high-throughput analytical platform, where nano-liter sized droplets, or samples, are ejected acoustically from a sample well plate in a non-contact manner, and captured in an open port interface (OPI). The sample is diluted and transferred from the OPI to a mass spectrometer (MS) for analysis. An ejection may generate a one-second baseline wide peak on the standard system setup, which determines the analytical throughput to one well every second, or about 1 Hz, but other types of ejection may generate a throughput frequency that is higher than 1 Hz such as, e.g., throughput frequencies in a range of 1 Hz to 3 Hz, or throughput frequencies that are higher than 2.5 Hz or 3 Hz.

Currently, MS data is typically stored in a mode which is equivalent to liquid chromatography (LC)-time trace data. However, this data storage methodology may not be necessary for MS data where it is advantageous to access all masses within a specific range, or review the data as needed. In addition, mass analysis systems typically generate data in a single data stream which is then stored in a single temporary file, and the file is processed in a temporary file. Typically, this single file is then processed to allow splitting of the results in order to generate a single file for each well location on an analyzed plate. Accordingly, this data splitting may result in a data file that contains between 96 and 1538 samples, each requiring processing and analysis. Typically, the split data is stored in time profile mode, which introduces significant delays in file and data processing. Accordingly, there is a technical problem in that the data or storage overhead of such a data storage methodology typically produces a large size file, and the amount of data storage that is needed to store all this data is very large, which renders operation of the MS system and analysis of the resulting data more challenging. Examples of this disclosure provide a technical solution to the above technical problem and include a data reduction method and system that reduces the amount of data that is stored and processed to analyze MS data, which enables faster access to the analysis.

Various examples of the current disclosure provide a technical solution to the above technical problem, the technical solution including entering a list of multiple reaction monitoring (MRM) assays during batch submission, executing the MS analysis of the MRM assays across the well plate, processing the data so as to associate an intensity of each MRM channel with a corresponding well of the well plate, and storing the signal intensity, the corresponding well location, and the timing of the signal, as a single data file entry.

Other examples of the current disclosure also provide a technical solution to the above technical problem, the technical solution including executing an MS analysis, analyzing the resulting temporary data file to identify the start and end regions for each well, identifying the first points corresponding to the start region and adding, e.g., the first 3 spectra for the first point, identifying the last points corresponding to the end region and adding, e.g., the last 3 spectra for the last point, identifying a peak apex and adding, e.g., the 4 spectra across the peak apex. The method may also include saving the start, end and apex spectra as individual experiments with a time stamp encoding the corresponding well location of the sample, and storing the starting point, the apex, the ending point, the well location and/or one or more of the added (summed) spectra of the starting point, the apex or the ending point in a data repository.

### Ionization Devices

Although the sample ionization process is described above in the context of AEMS using OPI and ESI, other techniques of generating ionized samples may be used according to various examples of this disclosure. For example, ionized samples may be generated by desorption electrospray ionization (DESI), which is a combination of ESI and desorption ionization (DI) methods. In DESI, ionization takes place by directing an electrically charged mist to the sample surface that is a few millimeters away. The electrospray mist is pneumatically directed at the sample, thus forming splashed droplets that carry desorbed, ionized analytes. After ionization, the ions travel through air into the atmospheric pressure interface which is connected to the mass spectrometer.

Another ionization technique may include matrix-assisted laser desorption ionization (MALDI), which is an ionization technique that uses a laser energy absorbing matrix to create ions from large molecules with minimal fragmentation. In MALDI, a laser is fired at the matrix crystals in the dried-droplet spot. The matrix absorbs the laser energy; the matrix is desorbed and ionized (by addition of a proton) by this event. The hot plume produced during ablation contains many species: neutral and ionized matrix molecules, protonated and deprotonated matrix molecules, matrix clusters and nanodroplets.

Other ionization techniques may include rapid-fire mass spectrometry, liquid atmospheric pressure (LAP) MALDI, pneumatic ESI (which generates ions for mass spectrometry using electrospray by applying a high voltage to a liquid to produce an aerosol), and electron ionization (EI). EI may also be referred to as electron impact ionization or electron bombardment ionization, and is an ionization method in which energetic electrons interact with solid or gas phase atoms or molecules to produce ions. Any of the above techniques, as well as others that can perform sample ionization, may be used in examples of this disclosure.

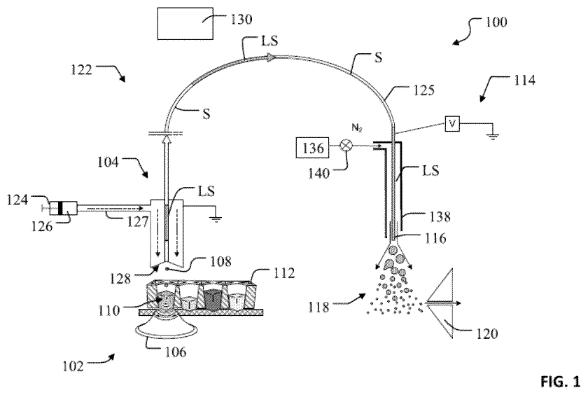

For illustrative purposes, FIG. 1 is a schematic view of an example system 100 combining an acoustic droplet ejection (ADE) 102 with an OPI sampling interface 104 and an ESI source 114, along with a mass spectrometer (MS) 120. Such a system 100 may be referred to as an acoustic ejection mass spectrometry (AEMS) system 100. The AEMS system 100 may include a mass analysis instrument such MS 120 for ionizing and mass analyzing analytes received within an open end of the sampling OPI 104. For example, the OPI 104 may be a sample receiver. Such a system 100 is described, for example, in U.S. Pat. No. 10,770,277, the disclosure of which is incorporated by reference herein in its entirety. The ADE 102 includes an acoustic ejector 106 that is configured to eject a droplet or sample 108 from a reservoir 110 of a well plate 112 into the open end of sampling OPI 104. As shown in FIG. 1, the example system 100 generally includes the sampling OPI 104 in liquid communication with the ESI source 114 for discharging a liquid containing one or more sample analytes (e.g., via electrospray electrode 116) into an ionization chamber 118, and a mass analyzer detector (e.g., a MS depicted generally at 120) in communication with the ionization chamber 118 for downstream processing and/or detection of ions generated by the ESI source 114. Due to the configuration of the nebulizer nozzle 138 and electrospray electrode 116 of the ESI source 114, samples ejected therefrom are transformed into small-volume liquid droplets flying in a gas. A liquid handling system 122 (e.g., including one or more pumps 124 and one or more transfer conduits 125) provides for the flow of liquid from a reservoir 126 to the sampling OPI 104 and from the sampling OPI 104 to the ESI source 114. As ESI source 114 allows for the formation of multiple charged ions and are, therefore, more applicable to a variety of applications, they are described within the application for consistency. The technologies described herein, however, may also be utilized for systems that incorporate a plurality of atmospheric pressure chemical ionization (APCI) sources.

In FIG. 1, the reservoir 126 (e.g., containing a liquid, desorption solvent, a sample to be tested, etc.) can be fluidically coupled to the OPI 104 via a supply conduit 127 through which the liquid can be delivered at a selected volumetric rate by the pump 124 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. As discussed in greater detail below, the flow of liquid into and out of the sampling OPI 104 occurs within a sample space accessible at the open end such that one or more droplets or samples 108 can be introduced into the liquid boundary 128 at the sample tip and subsequently delivered to the ESI source 114.

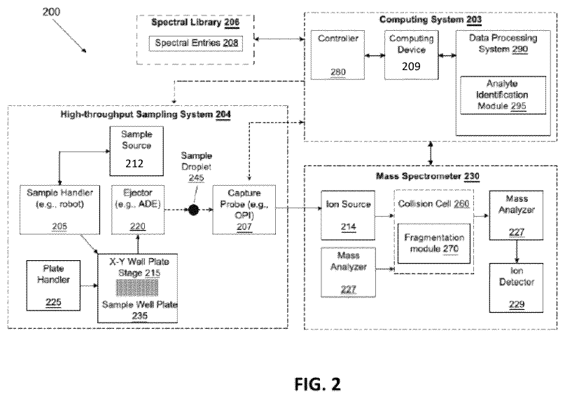

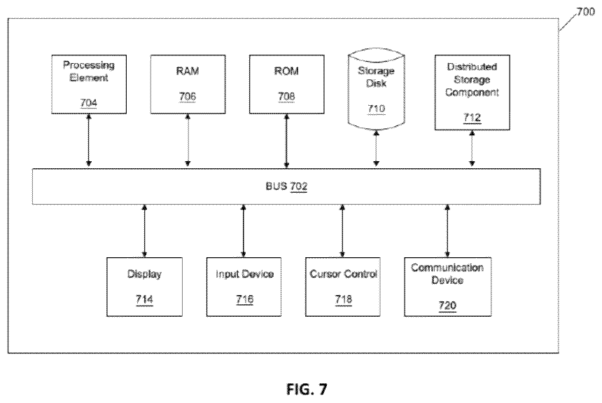

The system 100 includes an ADE 102 that is configured to generate acoustic ejection energy that is applied to a liquid contained within a reservoir 110 that causes one or more droplets or samples 108 to be ejected from the reservoir 110 into the open end of the sampling OPI 104. A controller 130 can be operatively coupled to and configured to operate any aspect of the system 100. This enables the acoustic transducer of the acoustic ejector 106 to inject droplets or samples 108 into the sampling OPI 104 as otherwise discussed herein substantially continuously, or for selected portions of an experimental protocol, by way of non-limiting example. Other types of sample introduction systems, such as gravity-based droplet systems may be utilized. ADE 102 and other non-contact ejection systems may be advantageous because of the high sample throughput that may be achieved. Controller 130 can be, but is not limited to, a microcontroller, a computer, a microprocessor, or any device capable of sending and receiving control signals and data, as described below with respect to the computing device illustrated in, e.g., FIG. 2 or FIG. 7. Wired or wireless connections between the controller 130 and the remaining elements of the system 100 are not depicted but would be apparent to a person of skill in the art.

As shown in FIG. 1, the ESI source 114 (when utilized) can include a source 136 of pressurized gas (e.g., nitrogen, air, or a noble gas) that supplies a high velocity nebulizing gas flow to the nebulizer nozzle 138 that surrounds the outlet tip of the electrospray electrode 116. As depicted, the electrospray electrode 116 protrudes from a distal end of the nebulizer nozzle 138. The pressured gas interacts with the liquid discharged from the electrospray electrode 116 to enhance the formation of the sample plume and the ion release within the plume for sampling by mass analyzer detector 120, e.g., via the interaction of the high-speed nebulizing flow and jet of liquid sample (e.g., analyte-solvent dilution). The liquid discharged may include liquid samples LS received from at least one reservoir 110 of the well plate 112. The liquid samples LS are diluted with the solvent S and typically separated from other samples by volumes of the solvent S (hence, as flow of the solvent S moves the liquid samples LS from the OPI 104 to the ESI source 114, the solvent S may also be referred to herein as a transport liquid). The nebulizer gas can be supplied at a variety of flow rates, for example, a flow rate in a range from about 0.1 L/min to about 40 L/min, which can also be controlled under the influence of controller 130 (e.g., via opening and/or closing valve 140).

It will be appreciated that the flow rate of the nebulizer gas can be adjusted (e.g., under the influence of controller 130) such that the flow rate of liquid within the sampling OPI 104 can be adjusted based, for example, on suction/aspiration force generated by the interaction of the nebulizer gas and the analyte-solvent dilution as it is being discharged from the electrospray electrode 116 (e.g., due to the Venturi effect/shock formation). The ionization chamber 118 can be maintained at atmospheric pressure, though in some examples, the ionization chamber 118 can be evacuated to a pressure lower than atmospheric pressure.

It will also be appreciated by a person skilled in the art and in light of the teachings herein that the mass analyzer detector 120 can have a variety of configurations. Generally, the mass analyzer detector 120 is configured to process (e.g., filter, sort, dissociate, detect, etc.) sample ions generated by the ESI source 114. By way of non-limiting example, the mass analyzer detector 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003; 17:1056-1064); and U.S. Pat. No. 7,923,681, entitled “Collision Cell for Mass Spectrometer,” the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 100 including, for example, an ion mobility spectrometer (e.g., a differential mobility spectrometer) that may be disposed between the ionization chamber 118 and the mass analyzer detector 120 and configured to separate ions based on their mobility difference in high-field and low-field). Additionally, it will be appreciated that the mass analyzer detector 120 can include a detector that can detect the ions that pass through the analyzer detector 120 and can, for example, supply a signal indicative of the number of ions per second that are detected.

FIG. 2 is a schematic diagram illustrating the operation of an example system combining acoustic droplet ejection (ADE) with an open port interface (OPI) sampling interface, which is a sample receiver, and electrospray ionization (ESI) source. In the illustrated example, the system 200 is operative to perform, e.g., high-throughput mass spectrometry analysis. Similar to the system 100 of FIG. 1, the system 200 includes a sampling system 204, a MS 230, a computing system 203, and optionally a spectral library 206 that may include a plurality of spectral entries 208.

In various aspects, the sampling system 204 may include at least one of a sample source 212 (similar to the reservoir 110 or well plate 112 of FIG. 1), a sample handler 205, a capture probe 207, an X-Y well plate stage 215, an ejector 220, and a plate handler 225. The sample source 212 and the sample handler 205 are operative to retrieve collections of samples from the sample source 212 and to deliver the retrieved collections to capture locations associated with sample capture probe 207. The system 200 may be operative to independently capture selected ones of the plurality of samples at the capture locations, e.g., capture probe 207, to optionally dilute the samples and to transfer the captured samples to MS 230 for mass analysis. In some examples, the sample source 212 may include a set of well plates in a storage housing and/or liquid for adding to well plates 235. The sample source 212 may include part of a liquid handling system that manipulates and/or injects liquid into the well plates 235. The sample handler 205 includes one or more electro-mechanical devices (e.g., robotics, conveyor belts, stages, and the like) that are capable of transferring samples (e.g., well plates) from the sample source 212 to other components of the sampling system 204 and/or to other components, such as the ejector 220 and/or the capture probe 207. As an example, the sample handler 205 may transfer a sample well plate 235 to the ejector 220 or the plate handler 225.

In various aspects, the ejector 220 is operable to eject droplets of samples 245 from the wells of the well plate 235. The size of the droplet or sample may typically be from 1 to 25 nanoliters. The ejector 220 may be any type of suitable ejector, such as an acoustic ejector, a pneumatic ejector, or another type of contactless ejector. In an example, the plate handler 225 receives a well plate 235 from the sample handler 205. The plate handler 225 transports the well plate 235 to a capture location that may be aligned with the capture probe 207. Once in the capture location, the ejector 220 ejects droplets 245 from one or more wells of the well plate 235. The plate handler 225 may include one or more electro-mechanical devices, such as a translation stage 215 that translates the well plate 235 in an X-Y plane to align wells of the well plate 235 with the ejector 220 and/or or the capture probe 207.

In various aspects, the MS 230 includes at least one of an ion source (e.g., ionization source) 214, a mass analyzer 227, an ion detector 229, and a collision cell 260. The MS 230 can be operative, for example, through use of ion source(s) or generator(s) 214 to produce sample ions of the sample introduced into the MS 230. The collision cell 260 is operative to fragment the precursor ions produced by the ion source 214 to generate product ions (fragment ions) derived from the precursor ions. In various examples, the mass analyzer 227 may be before the collision cell. The MS 230 is further operative to filter and detect selected ions of interest from the sample ions through the use of the mass analyzer 227 and ion detector 229. The mass analyzer 227 is operative to analyze the sample ions and produce a mass spectrometry dataset including all ion current signals from the sample ions.

In some aspects, the MS 230 is operative to perform tandem mass spectrometry analysis through the use of the collision cell 260. The collision cell 260 may further include a fragmentation module 270 operative to apply an energy to the selected precursor ions and cause the selected precursor ions to undergo fragmentation and generate product ions. The fragmentation module 270 may include at least one of collision induced dissociation (CID), surface induced dissociation (SID), electron capture dissociation (ECD), electron transfer dissociation (ETD), metastable-atom bombardment, photo-fragmentation, or combinations thereof.

It will also be appreciated by a person skilled in the art and in light of the teachings herein that the mass analyzer 227 can have a variety of configurations. Generally, the mass analyzer 227 is operative to process (e.g., filter, sort, dissociate, detect, etc.) sample ions generated by the ion source 214. By way of non-limiting example, the mass analyzer 227 may be a triple quadrupole mass spectrometer, or any other mass analyzer known in the art and modified in accordance with the teachings herein.

In various aspects, the computing system 203 may include a computing device 209 as described above, a controller 280, and a data processing system 290. For example, the data processing system 290 may include a data repository. The controller 280 may be in the form of electronic signal processors and in electrical communication with other subsystems within the system 200. The controller 280 may be operative to coordinate some or all of the operations of the pluralities of the various components of the system 200. In one example, the controller 280 may be a controller for the mass spectrometer 227 and may be used as the primary controller for controlling components in addition to those components housed within the mass spectrometer 227. As such, the controller 280 may be considered the main or central controller that orchestrates, or communicates with, the other controllers to carry out the operations discussed herein in a more efficient manner.

In various aspects, the data processing system 290 may include various components and modules operative to process mass spectrometry data and to provide real-time feedback to users and other subsystems. In some examples, the data processing system 290 further includes an analyte identification module 295. The analyte identification module 295 may be operative to perform a library search and predict compound identity of a target analyte in a test sample, optionally through use of the trained machine learning algorithm. In various examples, the computing system 203 may be similar to the computing device 700 described in greater detail below with respect to FIG. 7.

In operation, the sampling system 204 (including sample source 212 and sample handler 205) can iteratively deliver independent samples from a plurality of sample sources (e.g., a droplet from a well of well plate 235) to the capture probe 207. The capture probe 207 can dilute and transport each such delivered sample to the MS 230 disposed downstream of the capture probe 207 for ionizing the diluted sample. The mass analyzer 227 can receive generated ions from the ion source 214 and/or the collision cell 260 for mass analysis. The mass analyzer 227 is operative to selectively separate ions of interest from generated ions received from the ion source 214 and to deliver the ions of interest to the ion detector 229 that generates a mass spectrometer signal indicative of detected ions to the computing system 203. In some aspects, the separate ions of interest may be indicated in an analysis instruction associated with that sample. In some aspects, the separate ions of interest may be indicated in an analysis instruction identified by an indicia physically associated with the plurality of samples.

The system 200 may include, e.g., a commercial product in operative communication with a MS 230 and a controller for the capture probe 207, which may include, for example, a SCIEX OS computer available from SCIEX. The SCIEX OS computer includes a control controller for the capture probe 207, represented for example by SCIEX open port interface software, and a controller for the MS 230, which may be the SCIEX OS computer. The MS 230 and the controller for capture probe 207 may be further in operative communication with an ejector 220 and an X-Y well plate stage 215, which may be, for example, a liquid droplet ejector with embedded computer or processor. For the purposes of this disclosure, these distributed controller components may collectively be considered to be a system controller, and depending upon the configuration, may be centralized or distributed as is the case here. For instance, one of the controllers or controller components may send signals to the other controllers to control the respective devices.

In one particular example, the high-throughput system 200 employs the ADE-OPI-MS technology. The ADE-OPI-MS system according to the present disclosure relies on acoustic dispensing of droplets directly from the wells of the plate or sample source under analysis. The acoustically dispensed droplets, which are typically at nanoliter scale, with precise control and independent of the sample solvent, are acoustically ejected from the ejected sample and introduced to a vortex at the opening of the sample receiver or OPI and delivered directly to the ionization source of the MS for detection. The substantially small samples required, coupled with the method's resilience in handling unpurified samples, make this technology advantageous for direct sampling from the well plate or sample source. The ADE-OPI-MS system and method also offer significant speed advantages: with an average analysis time of 1-2 seconds per sample and a small quantity of 1-10 nanoliter per sample, such that a typical well plate containing 384 wells can be analyzed in under 15 min. Thus, the ADE-OPI-MS system advantageously enables high-throughput analysis of a large quantity of samples and generate a large volume of data within a meaning time frame such as a day. In addition, the ADE-OPI is compatible with both nominal and high-resolution mass spectrometers, allowing rapid quantification with the former, and extensive analyte identification with the latter. It should be noted that although the MS 230 is discussed herein, principles of the above examples may be applicable to any other mass analyzing device, or to any sample detection device.

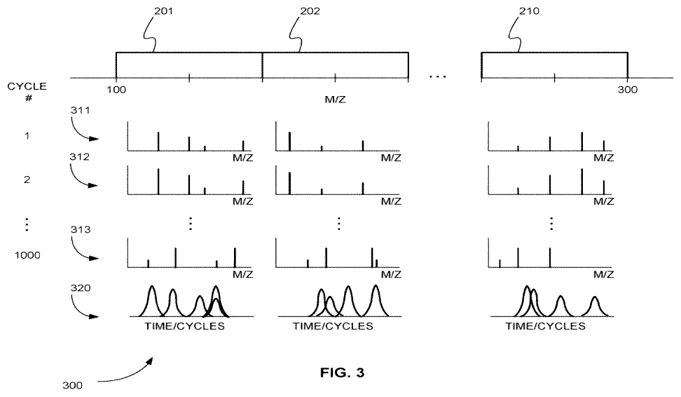

FIG. 3 is an example diagram illustrating the obtention of product ion traces from various precursor ion mass selection windows, in accordance with various examples of the disclosure. For example, a number of precursor ion mass selection windows such as, e.g., ten precursor ion mass selection windows, represented by precursor ion mass selection windows 201, 202 . . . 210 in FIG. 3, are selected and fragmented during each cycle for a total of, e.g., 1000 cycles. Although ten precursor ion mass selection windows are discussed above, the number of precursor ion mass selection windows may be lower or greater than ten. During each cycle, a product ion spectrum is obtained for each precursor ion mass selection window 201, 202 . . . 210. For example, product ion spectrum 311 is obtained by fragmenting precursor ion mass selection window 201 during cycle 1, product ion spectrum 312 is obtained by fragmenting the same precursor ion mass selection window 201 during cycle 2, and product ion spectrum 313 is obtained by fragmenting the same precursor ion mass selection window 201 during cycle 1000.

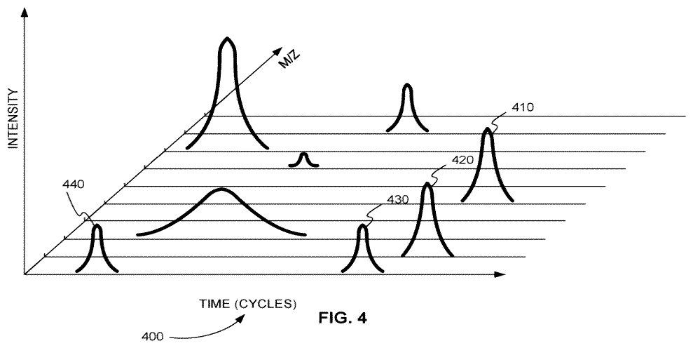

By plotting the intensities of the product ions in each product ion spectrum of each precursor ion mass selection window 201, 202 . . . 210 over time, XICs are obtained for each precursor ion mass selection window 201, 202 . . . 210. For example, the XIC plot 320 may be a combination of XICs and calculated for the 1,000^{th} product ion spectra of precursor ion mass selection window 201. The XIC plot 320 includes a combination of XIC peaks or traces for one or more of the product ions that are produced from fragmenting precursor ion mass selection window 201 during the 1000 cycles. It should be noted that XICs can be plotted in terms of time or cycles, as illustrated in the bottom portion of FIG. 3. The XIC plot 320 is illustrated as being plotted in two dimensions in FIG. 3. However, each XIC of each precursor ion mass selection window can be three-dimensional because each XIC peak may represent more than one m/z value, as further discussed with respect to FIG. 4 below.

FIG. 4 is an example diagram 400 that shows the three-dimensionality of an XIC obtained for a precursor ion mass selection window, such as any one of precursor ion mass selection windows 201, 202 . . . 210, over time, in accordance with various examples of the disclosure. In FIG. 4, the x-axis of the plot 400 is time or cycle number, the y-axis is product ion intensity, and the z-axis is the mass-to-charge ratio (m/z). From this three-dimensional plot 400, more information may be obtained. For example, peaks 410 and 420 both have the same shape and occur at the same time, or same retention time. However, peaks 410 and 420 have different m/z values. This may mean that peaks 410 and 420 are isotopic peaks or represent different product ions from the same precursor ion. If peaks 410 and 420 represent different product ions from the same precursor ion, they can be grouped into a peak group such as, e.g., XIC peak group 320 in FIG. 3. An XIC peak group is a group of one or more XIC peaks that have the same retention time. Similarly, peaks 430 and 440 have the same m/z value but occur at different times. This may mean that peaks 430 and 440 are the same product ion, but they are from two different precursor ions. peaks 430 and 440 show that an accurate retention time is needed to determine the correct product ion peak for each known compound.

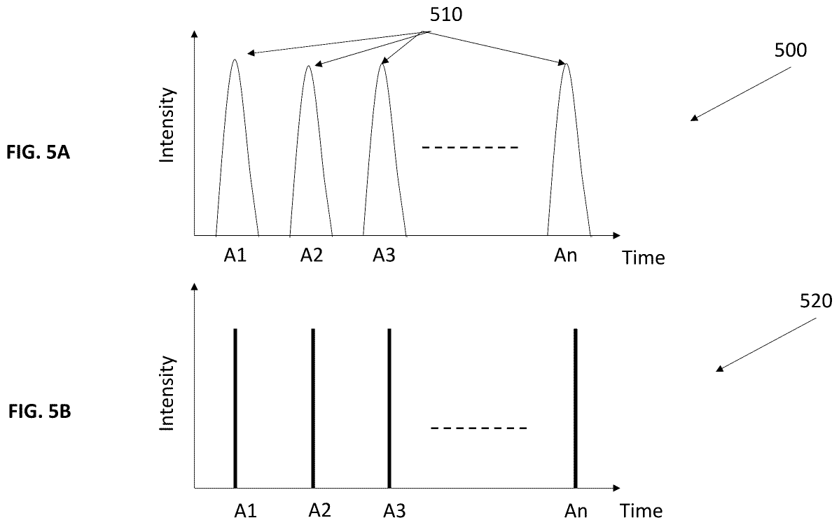

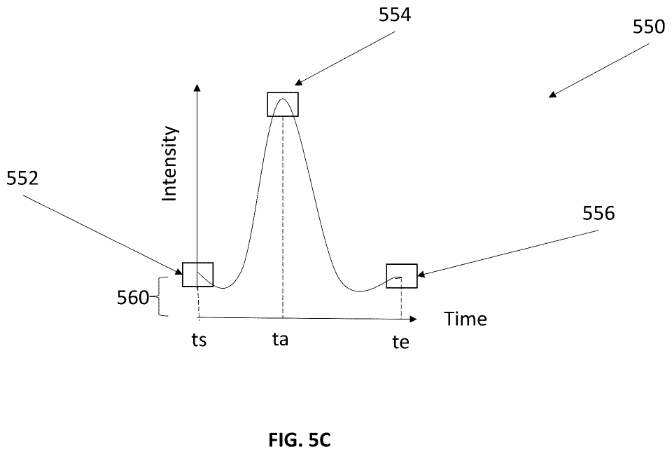

FIGS. 5A-5C illustrate data acquisition traces, according to various examples of the disclosure. In FIG. 5A, a spectrum 500 including a plurality of peaks A1 . . . An is illustrated for a MRM measurement for samples ejected from a well of a well plate, each peak A1 . . . An representing a separated peak taken from an ion chromatogram and corresponding to a target ionic mass. In various examples, each peak Ai in spectrum 500 also represents a separate well of a well plate, and for each of these wells, the highest point 510 of the peak, which corresponds to a highest intensity for that peak, may be derived and plotted as illustrated in the spectrum 520 of FIG. 5B. For example, the intensity of each peak in spectrum 520 may be the height 510 of the same peak of FIG. 5A. Accordingly, each well of the well plate may be represented by a single intensity, as illustrated in the spectrum 520 of FIG. 5B. As a result, the data that may be saved may include the intensity of the signal corresponding to each well, and the location of the corresponding well in the well plate. In examples, storing the signal intensity and the location of the corresponding well makes identifying the sample in the well plate easier and straightforward, and constitutes a reduced data set that may be used to identify the ionized sample. This data is substantially smaller than data representing a calculation of, e.g., the area under each peak A1 . . . An, and thus represents substantial savings in terms of the amount of memory that is necessary to store the data. In a further example, the reduced data set may be in the form of a table of values of mass-to-charge ratios (m/z) and intensities.

FIG. 5C illustrates a peak obtained from a MS analysis capturing a plurality of ionic masses for samples ejected from a well of a well plate. For example, the peak 550 is, similarly to the peaks illustrated in FIGS. 3 and 4, a combination of signals corresponding to a plurality of mass-to-charge ratios for a given well of the well plate. In examples, the peak 550 has a starting point 552, an apex 554, and an ending point 556. For example, a timing of the occurrence of the apex 554 may also be recorded as apex time or “ta,” a timing of the starting point may be recorded as “ts,” and a timing of the ending point may be recorded as “te.” In various examples, the starting point 552 may be determined as the combination of the first spectra for the measurement, e.g., may be determined as the combination, or sum, of the first three (3) spectra for the measurement. In other examples, the apex may be determined as the combination, or sum, of a number of measurement cycles, e.g., the sum of four (4) spectra, such as four spectra after the first three (3) spectra. In other examples, the ending point 556 may be determined as the combination of the last spectra for the measurement, e.g., may be determined as the combination, or sum, of the last three (3) spectra. In examples, when ten (10) measurement cycles are performed for a given peak, the first three (3) spectra may be for the starting point, the next four (4) spectra may be for the apex, and the last three (3) spectra may be for the ending point. As a result, a reduced data set may be created, and the data that is saved may include the intensity of the signal at the starting point of the peak, the intensity of the signal at the apex of the peak, the intensity of the signal at the ending point of the peak for each well and the added spectra at each of the start point 552, the apex 554 and end point 556. This data is substantially smaller than data representing a calculation of, e.g., the area under each peak, and thus represents a reduced data set and substantial savings in terms of the amount of memory that is necessary to store the data. In various examples, the peak 550 includes a noise background 560 that may be subtracted during analysis to extract a background-subtracted signal intensity of the apex 554.

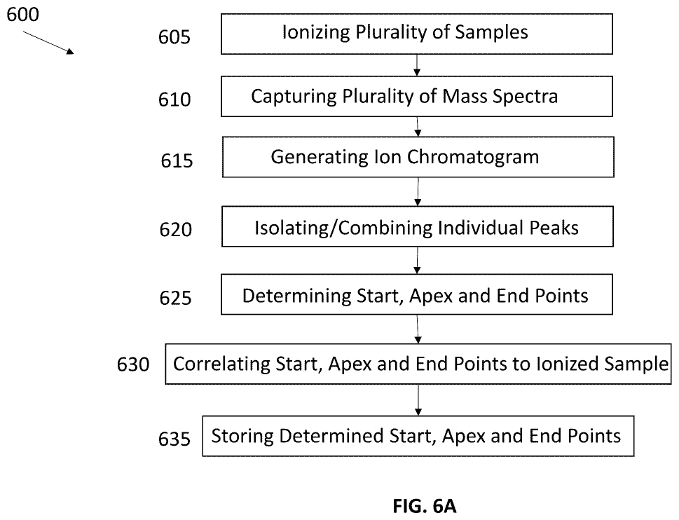

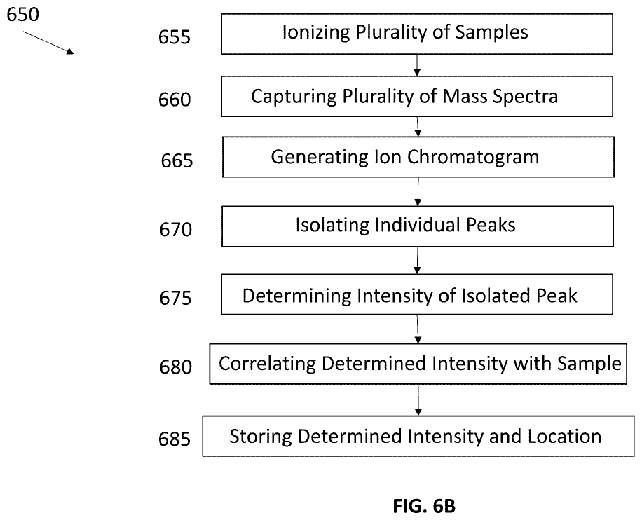

FIGS. 6A-6B are flow charts illustrating example methods for reducing data storage requirements in mass analysis systems, in accordance with various examples of the disclosure. FIG. 6A depicts example method 600, in accordance with various examples of the disclosure. For the sole purpose of convenience, methods 600 and 650 are described through use of the example systems 100 or 200 described above. However, it is appreciated that the methods 600 and 650 may be performed by any suitable system such as, e.g., MALDI, DESI, EI, rapid-fire mass spectrometry, or other ionization or mass analysis techniques or devices.

In various examples, operation 605 includes ionizing a plurality of samples. For example, each sample, located in an individual well of a well plate, may be ionized via an ionization device, in order to later be introduced in a mass analysis device. In examples, as discussed above, ionized samples may be generated by an ESI, a DI, or a DESI device. In other examples, the samples may be located in a well plate including a plurality of individual wells, each well holding a sample. In order to be ionized, a given sample of the plurality of samples may be ejected from the well and ionized via an ionization device.

In various examples, operation 610 includes, for each ionized sample, capturing a plurality of mass spectra. For example, the mass spectra may be captured for a range of mass-to-charge ratios over a given period of time corresponding to a cycle time of the given sample of the plurality of samples. In examples, operation 615 includes generating an ion chromatogram based on the captured plurality of mass spectra, the ion chromatogram being generated over a period of time.

In various examples, operation 620 includes isolating individual peaks from the ion chromatogram, and combining isolated individual peaks from the same ion mass selection window. For example, individual peaks may be separated by time periods corresponding to the ejection of each individual sample from their corresponding well. For example, a separated peak may correspond to the signal emitted from an individual well which holds an individual sample. In examples, isolating the individual peak during operation 620 may include combining a plurality of peaks during the period of time. Accordingly, operation 620 includes isolating individual peaks for each ion mass selection window, and combining the peaks from the same ion mass selection window that have different mass-to-charge ratios such as, e.g., the ion mass selection window 201 and the XIC plot 320 discussed above with respect to FIG. 3. The peak 550 illustrated in FIG. 5C is an example of such a separated peak.

In additional examples, operation 625 includes, for an individually separated peak, determining a starting point, an ending point, and an apex. In various examples, the apex may be determined by identifying the time corresponding to the apex, e.g., the apex time “ta” illustrated in FIG. 5C. In other examples, the apex may also be determined by identifying the time and by calculating a sum of a plurality of mass spectra collected during the same time period. For example, the apex may be determined by calculating a sum of four (4) mass spectra during that time period. In other examples, determining the starting point may be accomplished by identifying a starting time of the isolated individual peak such as, e.g., the starting time “ts” of the peak 550 illustrated in FIG. 5C, and calculating the sum of several mass spectra at the starting time of the isolated individual peak, e.g., calculating the sum of three (3) mass spectra at the starting time “ts” of the isolated individual peak 550. In other examples, determining the ending point may be accomplished by identifying an ending time of the isolated individual peak such as, e.g., the ending time “te” of the peak illustrated in FIG. 5C, and calculating the sum of several mass spectra at the ending time of the isolated individual peak, e.g., calculating the sum of three (3) mass spectra at the ending time “te” of the isolated individual peak 550.

In various examples, the background intensity of the signal collected during operation 610 may be determined. For example, the background intensity may be determined as the signal intensity at both the starting point and the ending point, as illustrated by background 560 in FIG. 5C, and operation 625 may further include subtracting that signal intensity at both the starting point and the ending point, which is the determined background intensity, from the measured intensity of the apex. Accordingly, the resulting apex signal may be a background-subtracted apex signal.

In various other examples, operation 630 includes correlating the determined starting point, ending point and apex to a given ionized sample of the plurality of samples. For example, operation 630 includes determining the well location of the sample for which the signal has been measured, and correlating the measured starting point, ending point and apex to the determined location of the ionized sample or well that holds the sample to be ionized in the well plate. For example, operation 630 includes establishing a relationship between the well location of the ionized sample, the measured starting point, the measured ending point, and the measured apex.

In other examples, operation 635 includes storing the correlated starting point, ending point, apex, well location and added (summed) spectra at one or more of the starting point, the apex and the ending point, in a data repository. For example, such correlation may allow to identify the ionized sample based on the location thereof in the well plate. For example, operation 635 may include determining a location of the ionized sample in the sample repository, e.g., the location of the well holding the sample to be ionized in the well plate. In examples, the sample repository as discussed herein includes the well plate in which a plurality of wells are defined, each well being configured to hold a given sample of the plurality of samples. Operation 635 may also include associating the location of the ionized sample with the determined starting point, apex and ending point, and then storing the associated location, the starting point, apex and ending point together in a memory or data repository with one or more mass spectra or added (summed) mass spectra. Accordingly, the combination of the starting point, ending point, apex and sample location may be sufficient to identify the sample, and may avoid the need to store larger amounts of data such as, e.g., the area under the peak of all the peaks generated during the MS analysis.

FIG. 6B is a flow chart depicting an example method 650 for reducing data storage requirements in mass analysis systems, in accordance with various examples of the disclosure. In various examples, operations 655-685 discussed below describe MRM measurements where a single ion source is targeted for measurement. For the sole purpose of convenience, method 650 is described through use of the example systems 100 or 200 described above. However, it is appreciated that the method 650 may be performed by any suitable system such as, e.g., MALDI, DESI, EI, rapid-fire mass spectrometry, or other ionization techniques or devices.

In various examples, operation 655 includes ionizing a plurality of samples. For example, each sample, located in an individual well of a well plate, may be ionized via an ionization device, in order to later be introduced in a mass analysis device. In examples, as discussed above, ionized samples may be generated by an ESI, a DI, or a DESI device. In other examples, the samples may be located in a well plate including a plurality of individual wells, each well holding a sample. In order to be ionized, a given sample of the plurality of samples may be ejected from the well and ionized via an ionization device.

In various examples, operation 660 includes, for each ionized sample, capturing a plurality of mass spectra. For example, the mass spectra may be captured for a range of mass-to-charge ratios over a given period of time corresponding to a cycle time of the given sample of the plurality of samples. In examples, operation 665 includes generating an ion chromatogram based on the captured plurality of mass spectra. For example, the ion chromatogram may be generated over a period of time.

In various examples, operation 670 includes isolating individual peaks from the ion chromatogram. For example, individual peaks may be separated by time periods corresponding to the ejection of each individual sample from their corresponding well. For example, a separated peak may correspond to the signal emitted from an individual well plate which holds an individual sample. In examples, isolating the individual peak during operation 670 may include isolating the peak corresponding to a target ionic mass during an MRM measurement. The peaks 510 illustrated in FIG. 5A are examples of such separated peaks that correspond to the signal emitted for a target ionic mass.

In additional examples, operation 675 includes determining the intensity of each peak separated during operation 670. Accordingly, because each peak is associated with a single sample location in the sample source such as, e.g., the well plate, operation 675 also includes determining the location of the sample for which the intensity that corresponds to the target ionic mass is measured.

In various other examples, operation 680 includes correlating the intensity determined during operation 675 with the well location of the sample in the well plate. For example, operation 680 includes establishing a relationship between the measured signal intensity for the target ionic mass and the location of the well in the well plate. In various other examples, operation 685 includes storing the correlated intensity for the target ionic mass and the location of the well in the well plate in a data repository such as, e.g., a memory. For example, storing the determined intensity may include determining the location of the ionized sample in the sample repository or well plate, associating the location of the sample in the well plate with the determined intensity, and storing the associated location and determined intensity in the data repository. Accordingly, the combination of the measured signal intensity for the target ionic mass and the sample location may be sufficient in an MRM measurement to identify the sample, and may avoid the need to store larger amounts of data such as, e.g., the area under the peak of all the peaks generated during the analysis.

FIG. 7 depicts a block diagram of a computing device similar to the computing device 209 discussed above with respect to FIG. 2. In the illustrated example, the computing device 700 may include a bus 702 or other communication mechanism of similar function for communicating information, and at least one processing element 704 (collectively referred to as processing element 704) coupled with bus 702 for processing information. As will be appreciated by those skilled in the art, the processing element 704 may include a plurality of processing elements or cores, which may be packaged as a single processor or in a distributed arrangement. Furthermore, a plurality of virtual processing elements 704 may be included in the computing device 700 to provide the control or management operations for, e.g., the mass analysis systems 100 and 200 illustrated above.

The computing device 700 may also include one or more volatile memory(ies) 706, which can for example include random access memory(ies) (RAM) or other dynamic memory component(s), coupled to one or more busses 702 for use by the at least one processing element 704. Computing device 700 may further include static, non-volatile memory(ies) 708, such as read only memory (ROM) or other static memory components, coupled to busses 702 for storing information and instructions for use by the at least one processing element 704. A storage component 710, such as a storage disk or storage memory, may be provided for storing information and instructions for use by the at least one processing element 704. As will be appreciated, the computing device 700 may include a distributed storage component 712, such as a networked disk or other storage resource available to the computing device 700. In examples, any of the volatile memory(ies) 706, the non-volatile memory(ies) 708, the storage component 710 and the distributed storage component may be referred to as a data repository.

The computing device 700 may be coupled to one or more displays 714 for displaying information to a user. Optional user input device(s) 716, such as a keyboard and/or touchscreen, may be coupled to Bus 702 for communicating information and command selections to the at least one processing element 704. An optional cursor control or graphical input device 718, such as a mouse, a trackball or cursor direction keys for communicating graphical user interface information and command selections to the at least one processing element. The computing device 700 may further include an input/output (I/O) component, such as a serial connection, digital connection, network connection, or other input/output component for allowing intercommunication with other computing components and the various components of, e.g., the mass analysis systems 100 and 200 discussed above.

In various examples, computing device 700 can be connected to one or more other computer systems via a network to form a networked system. Such networks can for example include one or more private networks or public networks, such as the Internet. In the networked system, one or more computer systems can store and serve the data to other computer systems. The one or more computer systems that store and serve the data can be referred to as servers or the cloud in a cloud computing scenario. The one or more computer systems can include one or more web servers, for example. The other computer systems that send and receive data to and from the servers or the cloud can be referred to as client or cloud devices, for example. Various operations of, e.g., the mass analysis systems 100 and 200 may be supported by operation of the distributed computing systems.

The computing device 209 discussed above with respect to FIG. 2, similar to the computing device 700, may be operative to control operation of the components of the mass analysis system 200 and the sampling system 204 through a communication device such as, e.g., communication device 720, and to handle data generated by components of the mass analysis system 200 through the data processing system 200.

In some examples, analysis results are provided by the computing device 700 in response to the at least one processing element 704 executing instructions contained in memory 706 or 708 and performing operations on data received from the mass analysis system 200. Execution of instructions contained in memory 706 and/or 708 by the at least one processing element 704 can render, e.g., the mass analysis systems 100 and 200 and associated sample delivery components operative to perform methods described herein.

The term “computer-readable medium” as used herein refers to any media that participates in providing instructions to the processing element 704 for execution. Such a medium may take many forms, including but not limited to, non-volatile media, volatile media, and transmission media. Non-volatile media includes, for example, optical or magnetic disks, such as disk storage 710. Volatile media includes dynamic memory, such as memory 706. Transmission media includes coaxial cables, copper wire, and fiber optics, including the wires that include bus 702.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to the processing element 704 for execution. For example, the instructions may initially be carried on the magnetic disk of a remote computer. The remote computer can load the instructions into its dynamic memory and send the instructions over a telephone line using a modem. A modem local to computing device 700 can receive the data on the telephone line and use an infra-red transmitter to convert the data to an infra-red signal. An infra-red detector coupled to bus 702 can receive the data carried in the infra-red signal and place the data on bus 702. Bus 702 carries the data to memory 706, from which the processing element 704 retrieves and executes the instructions. The instructions received by memory 706 and/or memory 708 may optionally be stored on storage device 710 either before or after execution by the processing element 704.

In accordance with various examples, instructions operative to be executed by a processing element to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A method for reducing data storage requirements in mass spectrometry data analysis, the method comprising:
ionizing a plurality of samples from a sample repository; and
for at least one ionized sample of the plurality of samples:
capturing a plurality of mass spectra over a period of time;
generating an ion chromatogram based on the captured plurality of mass spectra, the ion chromatogram extending over the period of time;
isolating an individual peak of the ion chromatogram;
determining at least one of a starting point, an apex, and an ending point of the isolated individual peak;
correlating the determined at least one of the starting point, the apex and the ending point to the ionized sample; and
storing the correlated at least one of the starting point, the apex, the ending point and the ionized sample in a data repository.

2. The method of claim 1, further comprising identifying the ionized sample based on the determined starting point, apex, and ending point.

3. The method of claim 1, wherein determining the apex comprises:
identifying an apex time of the isolated individual peak; and
calculating a first sum of a first plurality of mass spectra at the apex time of the isolated individual peak.

4. The method of claim 3, wherein calculating the first sum comprises calculating the sum of four spectra at the apex time of the isolated individual peak.

5. The method of claim 1, wherein determining the starting point comprises:
identifying a starting time of the isolated individual peak; and
calculating a second sum of a second plurality of mass spectra at the starting time of the isolated individual peak.

6. The method of claim 5, wherein calculating the second sum comprises calculating the sum of three spectra at the starting time of the isolated individual peak.

7. The method of claim 1, wherein determining the ending point comprises:
identifying an ending time of the isolated individual peak; and
calculating a third sum of a third plurality of mass spectra at the ending time of the isolated individual peak.

8. The method of claim 7, wherein calculating the third sum comprises calculating the sum of three spectra at the ending time of the isolated individual peak.

9. The method of claim 1, wherein storing the correlated at least one of the starting point, the apex, the ending point and the ionized sample comprises:
determining a location of the ionized sample in the sample repository;
associating the location of the ionized sample with the determined at least one of the starting point, the apex and the ending point; and
storing the associated location and the determined at least one of the starting point, the apex and the ending point in the data repository.

10. The method of claim 1, further comprising:
determining a background intensity at the starting point and at the ending point of the isolated individual peak;
wherein determining the apex of the isolated individual peak comprises subtracting the determined background intensity from an intensity of the determined apex.

11. The method of claim 1, wherein isolating the individual peak comprises combining a plurality of peaks during the period of time.

12. A method for reducing data storage requirements in mass spectrometry data analysis, the method comprising:
ionizing a plurality of samples from a sample repository; and
for at least one ionized sample of the plurality of samples:
capturing a plurality of mass spectra over a period of time;
generating an ion chromatogram for the ionized sample based on the captured plurality of mass spectra, the ion chromatogram extending over the period of time;
isolating an individual peak of the ion chromatogram;
determining an intensity of the isolated individual peak;
correlating the determined intensity with the ionized sample; and
storing the correlated intensity and the ionized sample in a data repository.

13. The method of claim 12, further comprising identifying the ionized sample based on the determined intensity.

14. The method of claim 12, wherein storing the correlated intensity comprises:
determining a location of the ionized sample in the sample repository;
associating the location of the ionized sample with the determined intensity; and
storing the associated location and the determined intensity in the data repository.

15-29. (canceled)

30. A sample analyzing system comprising:
a sample receiver;
an ionization device coupled to the sample receiver;
a mass analysis device fluidically coupled to the ionization device;
a processor operatively coupled to the sample receiver and to the mass analysis device; and
a memory coupled to the processor, the memory storing instructions that, when executed by the processor, perform a set of operations comprising:
ionizing, at the ionization device, a plurality of samples from a sample repository; and
for at least one ionized sample of the plurality of samples, the set of operations comprises:
capturing, at the mass analysis device, a plurality of mass spectra over a period of time;
generating, via the processor, an ion chromatogram for the ionized sample based on the captured plurality of mass spectra, the ion chromatogram extending over the period of time;
isolating, via the processor, an individual peak of the ion chromatogram;
determining, via the processor, an intensity of the isolated individual peak;
correlating, via the processor, the determined intensity with the ionized sample; and
storing, at the memory, the correlated intensity and the ionized sample.

31. The sample analyzing system of claim 30, wherein the set of instructions further comprises identifying the ionized sample based on the determined intensity.

32. The sample analyzing system of claim 30 wherein the set of instructions further comprises storing the determined intensity by:
determining a location of the ionized sample in the sample repository;
associating the location of the ionized sample with the determined intensity; and
storing the associated location and determined intensity in the memory.
